(19) United States
(12) Patent Application Publication
(10) Pub. No.: US 2004/0167282 A1
(43) Pub. Date: Aug. 26, 2004

(54) Composition based on a heterogeneous PVDF and on an aromatic bis-imide, that can be crosslinked by ionizing radiation

(76) Inventors: Thierry Pascal, Beaumont le Roger (FR); Abderrahim Maazouz, Villeurbanne (FR)

Correspondence Address: Thomas F. Roland, Esq., ATOFINA Chemicals, Inc., Patent Department, 2000 Market Street, 26th Floor, Philadelphia, PA, 19103-3222, US

(21) Appl. No.: 10/742,964

(22) Filed: Dec. 22, 2003

(30) Foreign Application Priority Data
Dec. 24, 2002 (FR) FR02.16606

(51) Int. Cl. C08J 3/28

(52) U.S. Cl. 525/109

(57) ABSTRACT

The present invention relates to a composition based on a heterogeneous PVDF and on an aromatic bis-imide that can be crosslinked by ionizing radiation, in which the heterogeneous PVDF is a copolymer of vinylidene fluoride (VDF) and a comonomer, the said heterogeneous PVDF comprising:

one or more discrete domains of VDF-comonomer copolymer;

one or more discrete domains of PVDF homopolymer containing at least 50% of the VDF of the heterogeneous PVDF;

where the proportion of comonomer is between 1 and 20% by weight of the heterogeneous PVDF.

Advantageously, the comonomer of the VDF in the heterogeneous PVDF is hexafluoropropylene (HFP).

### FIELD OF THE INVENTION

The present invention relates to a composition based on a heterogeneous PVDF (polyvinylidene fluoride) and on an aromatic bis-imide that can be crosslinked together by ionizing radiation.

### BACKGROUND OF THE INVENTION

Polymers based on vinylidene fluoride (VDF) are known to offer excellent mechanical properties, very great chemical inertness, and good fire and ageing resistance. These qualities are exploited in various fields of application. Mention may be made, for example, of the manufacture of extruded, injection-moulded or compression-moulded parts for the chemical engineering or microelectronics industry, the use in the form of impermeable tubing for transporting gases or hydrocarbons, and the production of covering layers for electrical wiring and cable assemblies in the motor vehicle industry.

The heterogeneous PVDF used in the present invention may be represented very schematically by a PVDF homopolymer matrix in which VDF/comonomer copolymers are dispersed. Thus, this heterogeneous PVDF is much more flexible than a PVDF homopolymer, but its melting point is that of the PVDF homopolymer. The PVDF is called heterogeneous in contrast to a VDF-comonomer copolymer in which all the chains contain VDF and comonomer, this copolymer therefore being homogeneous. On the other hand, this (homogeneous) copolymer, which is also much more flexible than a PVDF homopolymer, has a lower melting point than that of a PVDF homopolymer.

### PRIOR ART AND THE TECHNICAL PROBLEM

In some cases, it appears that the level of mechanical performance of the above materials is insufficient, for example in terms of elastic modulus, yield stress or elongation at break in tension or in bending. This limitation relates to the mechanical behaviour at room temperature and the mechanical behaviour that can be observed in a higher temperature range, typically lying above 150° C.

Under very specific extreme application conditions or end-uses, the retention of mechanical cohesion, characterized for example by a lack of flow at temperatures above the melting point of the original fluoropolymer, may be required. This is the case for the motor vehicle cable application, which requires dimensional stability to be maintained up to 200° C. in respect of the T5 specification, i.e. more than 30° C. above the melting point of the virgin polymer. This property may be characterized by the existence of a rubbery plateau in the melt, which will be associated with elastic modulus value typically greater than 10⁵ Pa.

In addition, even if the initial level of mechanical performance proves to be satisfactory, the thermal stability of the product may constitute the limiting factor for the application. This is because, for most of the abovementioned end-uses the product will remain at high temperatures, generally above 130° C., for hundreds, if not thousands, of hours, for example in direct contact with the ambient air. This lack of thermal stability results in a progressive loss of end-use properties. From the standpoint of mechanical performance it is, for example, the elastic modulus and the elongation at break which are impaired. It should be added that the weight loss that accompanies the thermal degradation is a key element, because it affects the change in dimensional characteristics of the finished part and because it produces local density variations liable to act as fracture initiators.

In the particular case of the cable application, the T5 specification stipulates the following thermal ageing conditions: 200° C. for 245 hours and 175° C. for 3000 hours. The principle of the standard test consists in winding the cable on a cylinder of well-defined diameter before applying the heat treatment. The acceptance criterion corresponds to the possibility of unwinding the aged cable without the polymer layer fracturing or cracking. To simulate the test conditions, we have taken into account both the change in tensile properties and the weight loss of the material.

Patent Application WO 99/25747 discloses a process for raising the mechanical performance of PVDF, which consists in introducing thermosetting additives (bis-maleimides or bis-nadimides). By definition, the crosslinking of the additive is carried out by raising the composition to a high temperature, typically above 200° C. The main drawbacks of this approach are the absence of a co-crosslinking reaction between the thermoplastic matrix and the additive, and the difficulty of controlling the final morphology. The need to use prolonged heat treatments to carry out the crosslinking step is also a disadvantage for the process. In addition, this approach discloses only PVDF homopolymers or copolymers and does not relate to heterogeneous PVDFs.

U.S. Pat. No. 6,156,847 discloses heterogeneous PVDFs based on copolymers of VDF and CTFE (chlorotrifluoroethylene) in which allyl derivatives, such as triallyl isocyanurate (TAIC) or triallyl cyanurate (TAC), and bis-malemide derivatives, such as N,N′-ethylene bis-maleimide, are added. The composition obtained is then formed and the object obtained is crosslinked by ionizing radiation. In the description, the aromatic bis-maleimides are not mentioned, only the N,N′-ethylene bis-maleimide is mentioned, the examples using only TAIC.

Japanese Patent Application JP 61-307388 A published on 2 Jul. 1988 discloses the combination of PVDF and aromatic bis-maleimides for producing radiation-crosslinkable layers. In that application, there is no mention of VDF-based heterogeneous copolymers.

U.S. Pat. No. 3,580,829 discloses compositions similar to those above.

Patent application US 2001-0023776 A1 discloses the use of heterogeneous VDF/HFP fluorocopolymers (improperly called “block copolymers”) in formulations for the motor vehicle cable application. TAIC and TAC are the only radiation-crosslinkable additives mentioned, nor is there any reference to a possible increase in thermal stability associated with a particular chemical structure of the additive. This formulation allows the T4 specification (245 hours at 175° C./3000 hours at 150° C.) to be met, but it does not meet the T5 specification.

The compositions of the present invention are based on heterogeneous fluoropolymers and on aromatic bis-imides, that can be crosslinked under the effect of ionizing radiation, having improved thermal stability under T5-type ageing conditions (245 hours at 200° C./3000 hours at 175° C). They are particularly useful for the manufacture of the secondary insulation layer of cables used in motor vehicles.

### SUMMARY OF THE INVENTION

The present invention relates to a composition based on a heterogeneous PVDF and on an aromatic bis-imide that can be crosslinked by ionizing radiation, in which the heterogeneous PVDF is a copolymer of vinylidene fluoride (VDF) and a comonomer, the said heterogeneous PVDF comprising:

one or more discrete domains of VDF-comonomer copolymer;

one or more discrete domains of PVDF homopolymer containing at least 50% of the VDF of the heterogeneous PVDF;

the proportion of comonomer being between 1 and 20% by weight of the heterogeneous PVDF.

Advantageously, the comonomer of the VDF in the heterogeneous PVDF is hexafluoropropylene (HFP).

### DETAILED DESCRIPTION OF THE INVENTION

With regard to the heterogeneous PVDF and firstly to its comonomer, this may be chosen from CTFE and HFP. The proportion of comonomer may be between 1 and 20%, advantageously between 1 and 15% and preferably between 5 and 15%, by weight of the heterogeneous PVDF. The melting point of the heterogeneous PVDF is advantageously between 160 and 170° C. and preferably between 163 and 168° C. Advantageously, the heterogeneous PVDF may include another comonomer in addition to the CTFE or HFP and may be chosen from monomoners that can be copolymerized with the VDF. As an example, mention may be made of CTFE or HFP (if the heterogeneous PVDF already contains HFP or CTFE), tetrafluoroethylene, trifluoroethylene, vinyl fluoride and pentafluoropropylene.

Such heterogeneous PVDFs are disclosed in Patent EP 280 591 (CTFE comonomer) and in U.S. Pat. Nos. 5,093,427 and 6,187,885 (HFP comonomer). Advantageously, the heterogeneous PVDF is that whose comonomer is HFP.

With regard to the aromatic bis-imide, mention may be made, for example, of bis-maleimides and bis-nadimides. Aromatic bis-imides may be defined as the products resulting from the reaction of two moles of an unsaturated dicarboxylic acid anhydride with an aromatic diamine. Advantageously, these are products of the following formulae (1) and (2):

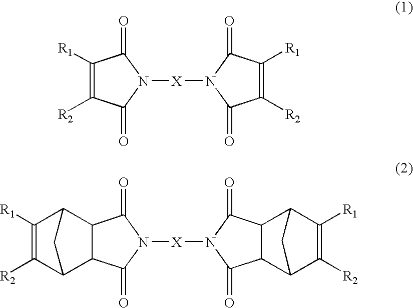

in which R₁ and R₂ mean, independently of each other, hydrogen or a linear or branched C₁-C₂₄ alkyl residue or a C₅-C₁₂ cycloalkyl, C₆-C₂₄ aryl, C₄-C₂₄ heteroaryl, C₇-C₂₄ aralkyl or C₇-C₂₄ alkaryl residue;

in particular, hydrogen or a linear or branched C₁-C₁₈ alkyl residue or a C₅-C₈ cycloalkyl, C₆-C₁₈ aryl, C₄-C₁₈ heteroaryl, C₇-C₁₈ aralkyl or C₇-C₁₈ alkaryl residue;

preferably, hydrogen or a linear or branched C₁-C₁₂ alkyl residue or a C₅-C₈ cycloalkyl, C₆-C₁₈ aryl, C₇-₁₈ aralkyl or C₇-C₁₈ alkaryl residue;

especially hydrogen or a linear or branched C₁-C₁₂ alkyl residue or a cyclohexyl, phenyl, biphenyl, C₇-C₁₂ aralkyl or C₇-C₁₂ alkaryl residue;

in which X means a C₆-C₂₄ arylene, C₄-C₂₄ heteroarylene, C₇-C₂₄ aralkylene or C₇-C₂₄ alkarylene residue;

in particular, a C₆-C₁₈ arylene, C₄-C₂₈ heteroarylene, C₇-C₁₈ aralkylene or C₇-C₁₈ alkarylene residue;

preferably, a C₆-C₁₈ arylene, C₄-C₁₂ heteroarylene, C₇-C₁₈ aralkylene or C₇-C₁₈ alkarylene residue; and

especially, a phenylene, biphenylene, C₇-C₁₂ aralkylene or C₇-C₁₂ alkarylene residue.

Advantageously, X is the product of the following formula (3):

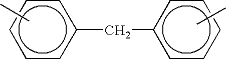

Preferably, the bis-imide is the bis-maleimide of methylene dianiline (BMI-MDA).

The bis-imides used in the present invention may be obtained by making a primary diamine H₂N—X—NH₂ react with an anhydride of the following formulae (4) and (5).

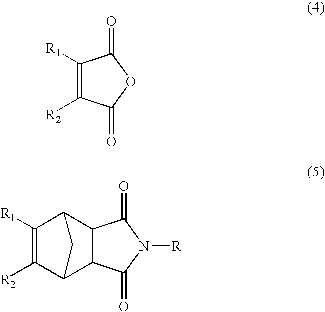

R₁, R₂ and X having the above meanings. In general, an intermediate compound is obtained which contains amide-acid or orthoamide-acid groups and which results in an imide compound by dehydration carried out chemically or thermally.

Numerous bis-maleimides in which R₁═R₂═H have been described in the work “High-Performance Thermosets” by Shiow-Ching Lin and Eli M. Pearce, Hanser Publishers, pp 13-29, 1994.

With regard to the proportions of heterogeneous PVDF and bis-imide, these may vary widely. Advantageously, the proportions of bis-imide are from 0.1 to 10% by weight for 99.9 to 90% of heterogeneous PVDF, respectively. Preferably, the proportions of bis-imide are from 1 to 5% by weight for 99 to 95% of heterogeneous PVDF, respectively.

Apart from the fluororesins and the imide compounds, the compositions according to the invention may also contain various additives and/or fillers and/or dyes and/or pigments, whether organic or mineral, macromolecular or non-macromolecular, well known in the literature.

As non-limiting examples of fillers, mention may be made of mica, alumina, talc, carbon black, glass fibres, carbon fibres and macromolecular compounds.

As non-limiting examples of additives, mention may be made of UV stabilizers, fire retardants and processing aids.

The sum of these various additives and fillers represents in general less than 20% of the total weight of the composition into which they are incorporated.

The compositions according to the invention may be prepared by melt-blending the fluororesins and the imide compounds—initially in powder, granule or solution form—in an extruder, or a two-roll mill, or in any suitable mixing apparatus.

It is also possible to mix a solution or latex of fluororesins with the imide compounds in powder or solution form.

The optional additives may be incorporated into the compositions, either when the fluororesins are being mixed with the imide additives, or prior to this step by mixing them with one or other of the constituents, or after this step, depending on the abovementioned techniques.

The compositions according to the invention may be used for producing articles, such as pipes, hollow containers, panels, sheets, laminates, mono- or multi-materials intended for the transportation and/or storage of hot fluids, especially hydrocarbons possibly under pressure in the offshore and on-shore oil industry, in the chemical engineering industry for components in contact with corrosive and/or abrasive fluids, and for producing boiler flues and flue ducts.

They may also be used to produce multilayer materials in the form of panels, sheets, films etc. prepared, for example, by coextrusion, lamination or bonding in solution or else as coatings for various substrates (based on resins, metals, wood and/or laminates) prepared, for example, by coating, lamination or casting. These materials may advantageously be used in the construction and building fields; as an example, mention may be made of coextruded panels for cladding, and bridge stays or cables protected by an external layer based on a composition according to the invention.

They may advantageously be used in the field of body parts for vehicles, especially motor vehicles, for domestic electrical appliances, etc.; as an example, mention may be made of ABS parts covered with a film based on a composition according to the invention.

The compositions according to the invention may advantageously be used to manufacture thermal or mechanical insulation layers for cables carrying electricity, used in electrical engineering or automobile applications; as an example, mention may be made of the external protection of copper-core cables used for equipping internal combustion engines.

The articles manufactured with the compositions of the invention are then subjected to ionizing radiation of sufficient intensity and for a sufficient time to cause crosslinking. These techniques are known per se and correspond, on an industrial scale, to exposure to beta (electron beam) radiation or gamma radiation. The ionizing radiation reactions involved depend closely on the irradiation dose applied to the composition. When common crosslinking is obtained between the bis-imide and the fluoropolymer, this generally leads to an improvement in the mechanical properties and in the thermal stability.

### EXAMPLES

The improvement in thermal stability was demonstrated by means of a comparison between compositions containing KYNARFLEX® 3120-50 and BMI-MDA and compositions containing KYNARFLEX® 3120-50 and TAIC.

KYNARFLEX® 3120-50 is a VDF/HFP heterogeneous PVDF having an MFI (Melt Flow Index) of 0.5 g/10 min at 230° C. under a load of 5 kg.

The formulations containing BMI-MDA and TAIC were prepared by melt-blending in a CLEXTRAL® BC 21 twin-screw extruder.

Starting from the formulation in granule form, various types of test specimens were manufactured either by injection moulding or by compression moulding. These test specimens were treated by beta radiation at a dose of 100 kGy before mechanical evaluation.

The initial mechanical properties were determined on the basis of the following data:

heat distortion temperature (HDT) on injection-moulded test specimens 4 mm in thickness according to the ISO 75 standard;

dynamic mechanical analysis (DMA) at a frequency of 1 Hz in tensile mode on a compression-moulded test specimen 1 mm in thickness. The value of the storage modulus E′ was used as significant datum.

The thermal stability was evaluated by determining the mechanical properties in tension of compression-moulded test specimens 0.4 mm in thickness according to the ISO 527 standard. The measurement was carried out before and after oven treatment at 200° C. for 245 hours. The weight loss of the specimens during thermal ageing was measured at the same time.

All of the results obtained are given in the table below.

Examination of the table shows that the composition containing BMI-MDA maintains its mechanical properties and has a minimum weight loss.

COMPOSITIONS IRRADIATED AT 100 kGy: MECHANICAL
PROPERTIES AND THERMAL STABILITY

| | | | KYNAR | KYNAR | KYNAR |
|---|---|---|---|---|---|
| | | KYNAR | 3120-50 + TAIC | 3120-50 + BMI-MDA | 3120-50 + BMI-MDA |
| | Specimen | 3120-50 | (5 wt %) | (3 wt %) | (5 wt %) |
| HDT (° C.) | Initial | 48 | 54.2 | 50.6 | 53.8 |
| DMA | | | | | |
| E′ at 0° C. | Initial | 1.47 × 10⁹ | 1.97 × 10⁹ | 1.57 × 10⁹ | |
| (Pa) | Initial | 2.10 × 10⁸ | 2.81 × 10⁸ | 2.09 × 10⁸ | |
| E′ at 100° C. | Initial | 1.00 × 10⁴ | 2.50 × 10⁶ | 6.28 × 10⁵ | |
| (Pa) | | | | | |
| E′ at 200° C. | | | | | |
| (Pa) | | | | | |
| TENSION | | | | | |
| Yield stress | Initial | 29 | 33 | 30 | 32 |
| (MPa) | Aged* | 27 | 27 | 27.5 | 30.5 |
| Elongation | Initial | 13.3 | 9.6 | 12.1 | 10.5 |
| at yield (%) | Aged* | 17 | 15 | 12.9 | 10.9 |
| Deformation | Initial | 435 | 214 | 300 | 242 |
| at break (%) | Aged* | 411 | 265 | 302 | 235 |
| Aged modulus*/ | | 0.75 | 0.62 | 0.89 | 40.92 |
| initial | | | | | |
| modulus | | | | | |
| WEIGHT LOSS | | 0.61 | 2.17 | 0.6 | 0.78 |
| (%)* | | | | | |

*Thermal ageing conditions: 200° C. for 245 hours.

What is claimed is:

1. A composition comprising a heterogeneous polyvinylidene fluoride (PVDF) and an aromatic bis-imide, wherein said composition can be crosslinked by ionizing radiation, wherein said heterogeneous PVDF is a copolymer of vinylidene fluoride (VDF) and a comonomer, and wherein said heterogeneous PVDF comprises:
a) one or more discrete domains of VDF-comonomer copolymer;
b) one or more discrete domains of PVDF homopolymer containing at least 50% of the VDF of the heterogeneous PVDF;
wherein the proportion of comonomer is between 1 and 20 percent by weight of the heterogeneous PVDF homopolymer.

2. The composition according to claim 1, in which the proportion of comonomer of the heterogeneous PVDF is between 1 and 15% by weight of the heterogeneous PVDF.

3. The composition according to claim 2, in which the proportion of comonomer of the heterogeneous PVDF is between 5 and 15% by weight of the heterogeneous PVDF.

4. The composition according to claim 1, in which the melting point of the heterogeneous PVDF is between 160 and 170° C.

5. The composition according to claim 4, in which the melting point of the heterogeneous PVDF is between 163 and 168° C.

6. The composition according to claim 1, in which the comonomer of the VDF in the heterogeneous PVDF is hexafluoropropylene (HFP).

7. The composition according to claim 1, characterized in that the proportions of bis-imide are from 0.1 to 10% by weight for 99.9 to 90% of heterogeneous PVDF, respectively.

8. The composition according to claim 7, in which the proportions of bis-imide are from 1 to 5% by weight for 99 to 95% of heterogeneous PVDF, respectively.

9. The composition according to claim 1, in which the bis-imide comprises the bis-maleimide of methylene dianiline (BMI-MDA).
